(19) United States
(12) Patent Application Publication
(10) Pub. No.: US 2014/0305393 A1
(43) Pub. Date: Oct. 16, 2014

(54) COMPRESSION RELIEF VALVE

(71) Applicant: ELECTRO-MOTIVE DIESEL, INC., LaGrange, IL (US)

(72) Inventors: Seema Farooqui, Westmont, IL (US); LeBlanc Martin, Munster, IN (US); Farhan Devani, Morton Grove, IL (US); Aaron G. Foege, Westmont, IL (US)

(73) Assignee: Electro-Motive Diesel, Inc., LaGrange, IL (US)

(21) Appl. No.: 13/861,541

(22) Filed: Apr. 12, 2013

(51) Int. Cl. F02B 77/08; F02F 1/24

(52) U.S. Cl. CPC F02B 77/089; F02F 1/24
USPC 123/41.55; 123/193.3; 374/144

(57) ABSTRACT

An engine includes a cylinder head and a cylinder block connected to the cylinder head at an interface. A compression relief valve is substantially inset in the cylinder head of the engine. The compression relief valve is connected to an engine control module via a wire harness. The compression relief valve includes a body having a bore. Further, the compression relief valve includes a needle inset in the bore. The compression relief valve includes a compression relief valve sensor assembly disposed in at least one of the body or the needle. The compression relief valve sensor assembly is configured to generate a cylinder head temperature signal proportional to a cylinder head temperature at the interface.

### TECHNICAL FIELD

This present disclosure relates generally to an engine, more particularly, to a compression relief valve for the engine.

### BACKGROUND

Heavy machines like locomotives or large mining trucks may run on different types of engines, such as internal combustion engines. The engines may incur failure due to several overheat conditions and water losses. The engine overheat conditions may be due to the failure of gaskets positioned in between a cylinder head and a cylinder block. The failure of gaskets may lead to leakage of coolant and mixing of oil and coolant leading to engine failures. Monitoring the functionality of the gasket can aid in avoiding cylinder water loss and ultimate engine failure.

U.S. Pat. No. 4,126,114 ('114 patent) discloses a temperature relief valve for an internal combustion engine. The temperature sensor valve in the '114 patent is configured to continuously sense the operating temperature of the engine or engine-driven accessory and reduces fluid pressure below an acceptable level of an engine protection device in response to an over-temperature condition or in response to a partial or complete loss of a liquid coolant. The temperature sensor valve includes a temperature sensing tip which is coupled to the housing of the engine or engine-driven accessory. A heat receiving section of the temperature-sensing tip receives heat from the housing and a heat dissipating section which protrudes into the coolant filled chamber transfers heat received from the heat receiving section into the coolant. The temperature sensing tip further includes an internal, longitudinally extending receptacle filled with a temperature responsive material which expands and contracts in response to the temperature of the temperature sensing tip. A partial or complete loss of coolant or an over-temperature condition will cause the temperature responsive material to expand and open a path in the temperature sensor valve which reduces the fluid pressure sensed by the engine protection device below the acceptable level and actuates the engine protection device to reduce the engine RPM to a safe level.

### SUMMARY

One unique component of the present disclosure is a compression relief valve. An engine includes a cylinder head and a cylinder block connected to the cylinder head at an interface. A compression relief valve is substantially inset in a cylinder head of the engine. The compression relief valve is connected to an engine control module via a wire harness. The compression relief valve includes a body having a bore. Further, the compression relief valve includes a needle inset in the bore. The compression relief valve includes a compression relief valve sensor assembly disposed in at least one of the body or the needle. The compression relief valve sensor assembly is configured to generate a cylinder head temperature signal proportional to a cylinder head temperature at the interface.

Another unique aspect of the present disclosure includes a method of determining an engine overheat condition. The method includes determining the current cylinder head temperature of the engine by the compression relief valve sensor assembly, inset in the compression relief valve. An engine control module is configured to compare the current cylinder head temperature with a predetermined cylinder head temperature. Moreover, the engine control module indicates the engine overheat condition, as a function of the difference of the current cylinder head temperature and the predetermined cylinder head temperature.

Other features and aspects of this disclosure will be apparent from the following description and the accompanying drawings.

### BRIEF DESCRIPTION OF THE DRAWINGS

FIG. 1 is a side view of a machine with an engine assembly;

FIG. 2 is an perspective view of the engine assembly of FIG. 1;

FIG. 3 illustrates a sectional view of a cylinder head of the engine assembly of FIG. 2;

FIG. 4 illustrates a sectional view of a compression relief valve sensor assembly; and

FIG. 5 illustrates a method of determining an engine overheat condition.

### DETAILED DESCRIPTION

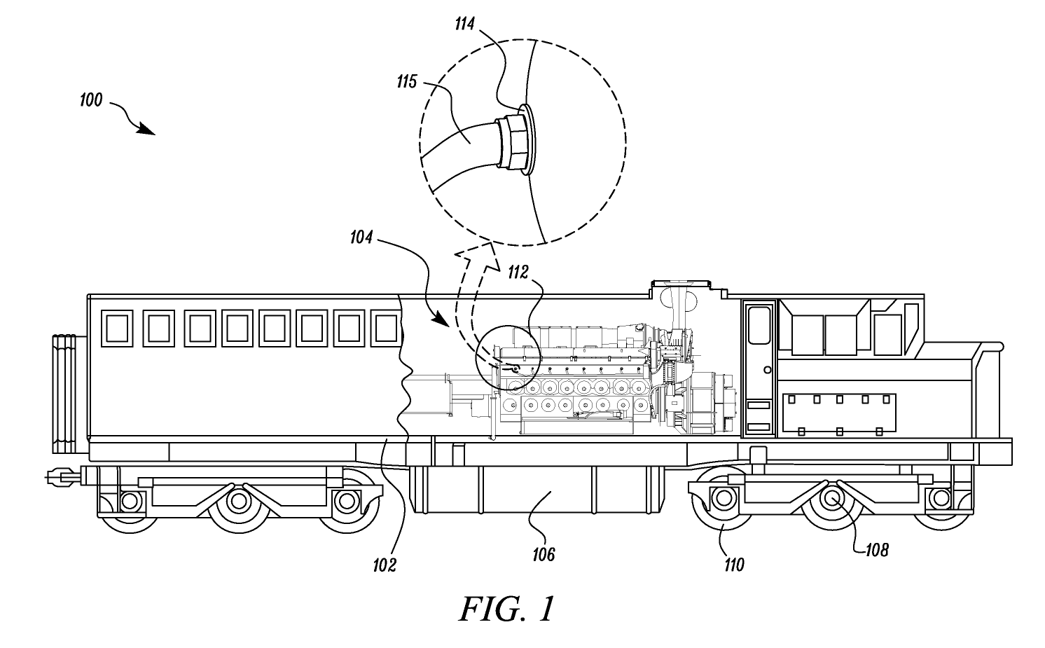

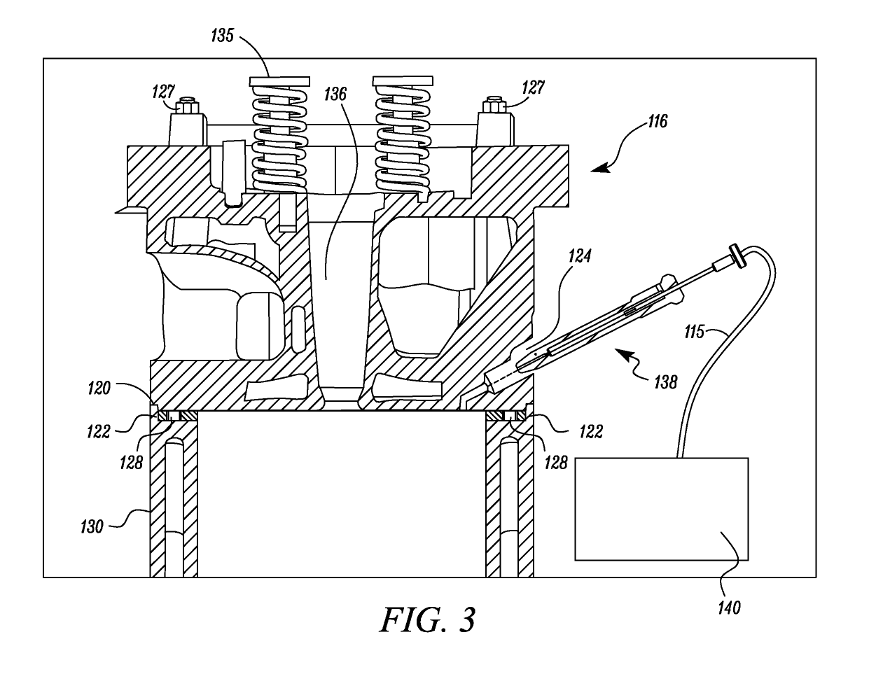

FIG. 1 illustrates a side view of a machine 100, such as a locomotive, in which various embodiments of the present disclosure are implemented. The machine 100 includes a frame 102. The frame 102 may support an engine assembly 104, a fuel tank 106 and various other components such as, but not limited to, power trains, hydraulic pumps, motors, valves, hydraulic lines, heat exchangers, and control systems. Further, the frame 102 may be disposed on one or more axles 108, associated with a plurality of wheels 110. In an aspect of the present disclosure, the frame 102 may be disposed on six axles 108, associated with the plurality of wheels 110. The engine assembly 104 may include plurality of engines 112. Further, the engine 112 may be of any type, for example, but not limited to, an internal combustion engine operated in a 2-stroke. The engine assembly 104 may include at least one compression relief valve 114. In an aspect of the present disclosure, each cylinder of the engine 112 may include a compression relief valve 114. Further, the compression relief valve 114 may be connected to an engine control module (as shown in FIG. 3). As illustrated in a magnified view, wire harnesses 115 may connect the compression relief valve 114 to the engine control module.

Further, the fuel tank 106 may be made of for example, but not limited, to a steel body of a standard size ISO (International Organization for Standardization) tank. The fuel tank 106 may further include plurality of openings and access points for removably connecting various hoses, control valves, etc. Further, fuel tank 106 may hold fuel, for example, but not limited to, diesel, gasoline, liquefied natural gas (“LNG”), compressed natural gas (“CNG”), and their equivalents. The fuel is supplied from the fuel tank 106 to the engine 112 via plurality of lines. The fuel tank 106 may include one or more filters and pumps. The filters may remove any impurities such as dirt or dust particles present in the fuel while the pumps may suck, pressurize and deliver the fuel to injectors of the engine 112. In alternative embodiments, the machine 100 may include one or more fuel tanks to hold one or more fuel.

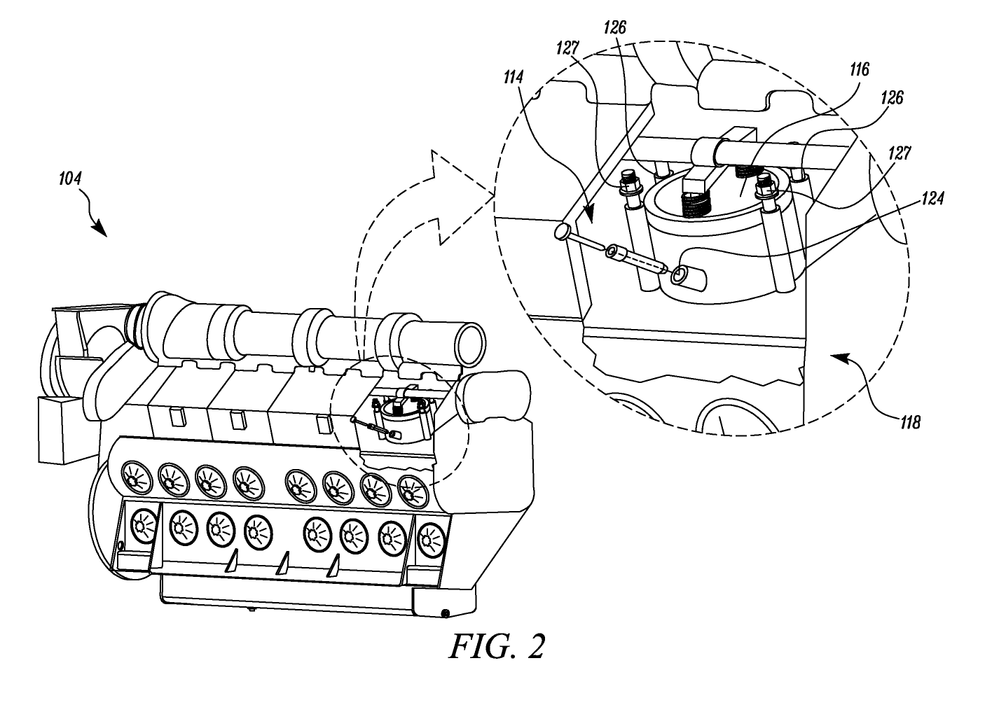

FIG. 2 illustrates an exploded view of the engine assembly 104 of FIG. 1. The engine assembly 104 may include a cylinder head 116 and a cylinder block 118 connected to the cylinder The cylinder block 118 may include a plurality of cylinder assemblies. In an aspect of the present disclosure, the cylinder block 118 may include a sixteen-cylinder assembly (only one side shown, eight cylinders on one side). The cylinder assemblies of the engine assembly 104 may be disposed in any configuration, such as, but not limited to, in-line engine configuration, V-engine configuration, U-engine configuration, or W-engine configuration. In an aspect of the present disclosure, the cylinder assemblies may be disposed in a V-engine configuration. The cylinder heads 116, cylinder block 118 and the gasket 122 may include openings 126 for receiving a mechanical fastener 127, such as, but not limited, to a bolt assembly. In an aspect of the present disclosure, the compression relief valve 114 may be inset in a port 124 provided in the cylinder head 116 of the engine assembly 104. (as illustrated in a magnified view)

FIG. 3 illustrates a sectional view of the cylinder head 116, according to an embodiment of the present disclosure. The cylinder head 116 of the engine 112 may include an exhaust valve 135 to allow exhaust gases to travel from exhaust passage to an exhaust manifold. The cylinder head 116 may further include an opening 136 to receive a fuel injector and/or a spark plug. The engine assembly 104 may further include a gasket 122 disposed between the cylinder head 116 and a cylinder liner 130 at the interface 120. The gasket 122 may include a plurality of coolant flow passages 128 adapted to exchange heat released through combustion process in the cylinder assembly of the engine assembly 104. In an aspect of the present disclosure, the coolant flow passages 128 may include sealing elements, such as, but not limited to, grommets.

In an aspect of the present disclosure, the compression relief valve 114 may include a CRV (Compression Relief Valve) sensor assembly 138. The CRV sensor assembly 138 may be configured to sense a cylinder head temperature closest to the sealing element disposed in the coolant flow passage 128 of the gasket 122 at the interface 120, as shown in FIG. 3.

In an embodiment of the present disclosure, the compression relief valve 114 is connected to the engine control module 140 via the wire harness 115. The engine control module 140 is configured to receive cylinder head temperature signals proportional to the cylinder head temperature from the compression relief valve 114. Further, the engine control module 140 may be configured to generate an engine overheat condition signal indicative of the engine overheat condition based on the cylinder head temperature signals. The engine control module's software is configured to generate the engine overheat condition signal indicative of the engine overheat condition based on the cylinder head temperature signals. Further, the engine control module 140 may selectively operate the engine 112 based on the engine overheat conditions. In an aspect of the present disclosure, the engine control module 140 may be configured derate or shutdown the engine 112 based on the engine overheat conditions. The engine control module 140 is operated by software to monitor the CRV sensor assembly 138 and its associated elements.

In an exemplary embodiment of the present disclosure, the engine control module 140 may include a microprocessor, an application specific integrated circuit (ASIC), or other appropriate circuitry, and may have memory or other data storage capabilities. The engine control module 140 may perform operations, include functions, steps, routines, data tables, data maps, charts, and the like, saved in, and executable from, read only memory, or another electronically accessible storage medium, to control the engine 112. Although in FIG. 3, the engine control module 140 is illustrated as a single, discrete unit, in other embodiments, the engine control module 140 and its functions may be distributed among a plurality of distinct and separate components. The single unit or multiple component engine control module 140 may be located on-board the engine assembly 104, a machine powered by the engine assembly 104, and/or in a remote location.

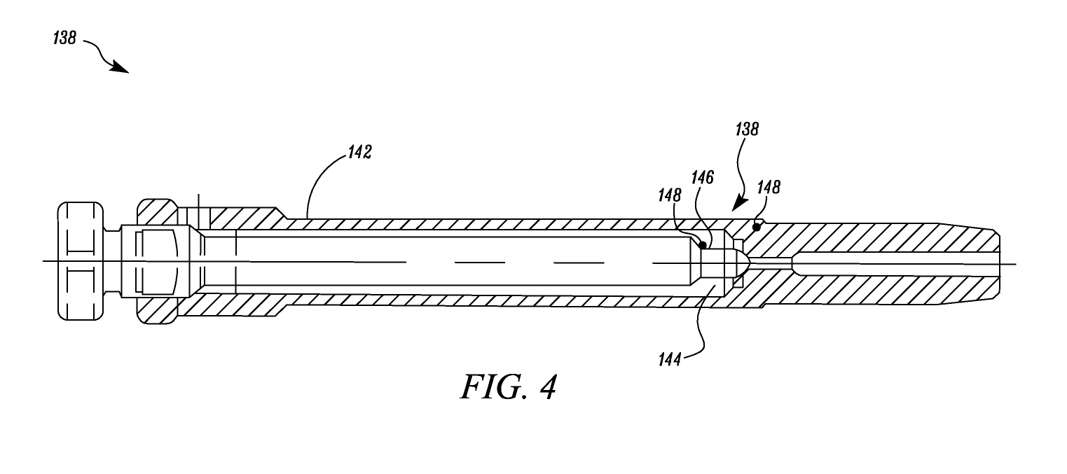

FIG. 4 illustrates the sectional view of the body 142 and needle 146, according to an aspect of the present disclosure. In an aspect of the present disclosure, the body 142 may include a longitudinal bore. Further, a needle 146 may be removably disposed in the bore 144. The CRV sensor assembly 138 may include a temperature sensing element 148 disposed in at least one of the body 142 or the needle 146. The temperature sensing element 148 is configured to generate the cylinder head temperature signal proportional to the cylinder head temperature closest to the sealing elements at the interface 120.

### INDUSTRIAL APPLICABILITY

The present disclosure is applicable to an engine assembly having compression relief valves, in which various embodiments of the present disclosure are implemented. Although the machine is embodied as a locomotive in the present disclosure, the machine may be such as, but not limited to, a large mining truck or an electric truck. An engine overheat condition may occur due to several conditions, such as, but not limited to, coolant temperature and pressure conditions and poor heat conductivity inside the engine because of accumulated deposits in a water jacket. Typically, to detect the engine overheat condition, one or more probes or transducers may be disposed in an inlet and outlet of the water jackets to measure temperature and pressure of the water. This method may not be an efficient solution, as the probes may sense high temperature, if the water entering the engine becomes hot, due to engine problems or inefficiencies in the water jackets. Further, the method often results in clogging of the sensors. The present disclosure detects the engine overheat conditions, if the sealing elements, for example, grommets present in a gasket become degraded or fail due to engine overheat conditions. Although the present disclosure is operable with an engine control module, a person ordinarily skilled in the art may understand that, the machine employing the present disclosure may be operated without the engine control module.

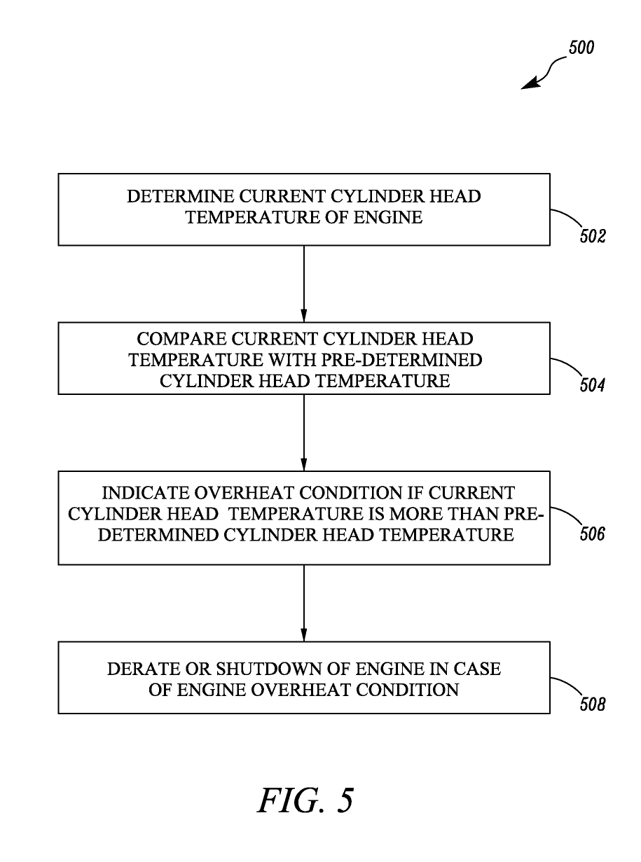

FIG. 5 illustrates a method 500 of determining the engine overheat condition, in accordance with an aspect of the present disclosure. At step 502, the CRV sensor assembly 138 disposed in the needle 146 may determine the cylinder head temperature signal proportional of the current cylinder head temperature of the engine 112. The CRV sensor assembly 138 sends the generated cylinder head temperature signals to the engine control module 140 via the wire harness 115. At step 504, the engine control module 140 compare the current cylinder head temperature with a predetermined cylinder head temperature. The engine control module 140 is loaded with the predetermined cylinder head temperatures. At step 506, the engine control module 140 may be further configured to generate the engine over heat condition signal indicative of the engine overheat condition based on the comparison of current cylinder head temperature with the predetermined cylinder head temperature. The engine control module 140 may indicate the engine overheat condition if the current cylinder head temperature is more than the predetermined cylinder head temperature. In an aspect of the present disclosure, the engine control module 140 may indicate the engine overheat condition, if the current cylinder temperature is about 25% more than the predetermined cylinder head temperature or normal operating temperatures of the engine 112. Further, at step 508, the engine control module 140 may derate or shutdowns the engine 112, in the case of the engine overheat condition.

In an aspect of the present disclosure, the CRV sensor assembly 138 disposed in the needle 146 will sense the cylinder head temperature closest to the sealing elements in the gasket 122 provided at the interface 120. The sealing elements may be more vulnerable to high temperatures and may degrade, leading to leakage of the coolant. The CRV sensor assembly 138 is designed to sense the cylinder head temperature closest to the sealing element and the engine control module 140 will derate or shutdown the engine 112 before it exceeds the degradation temperature of the sealing element.

The foregoing description provides examples of the present disclosure and engine overheat detection methodology. However, it is believed that other implementations of the disclosure may differ in detail from the foregoing examples. All references to the disclosure or examples thereof are intended to reference the particular example being discussed at that point and are not intended to imply any limitation as to the scope of the disclosure. All language of distinction and disparagement with respect to certain features is intended to indicate a lack of preference for those features, but not to exclude such from the scope of the disclosure entirely, unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order, unless otherwise indicated herein or otherwise clearly contradicted by context.

What is claimed is:

1. An engine comprising:
a cylinder head;
a cylinder block connected to the cylinder head at an interface; and
a compression relief valve substantially inset in the cylinder head, the compression relief valve comprising:
a body having a bore;
a needle disposed in the bore; and
a compression relief valve sensor assembly disposed in at least one of the body or the needle and configured to generate a cylinder head temperature signal proportional to a cylinder head temperature at the interface.

2. The engine of claim 1 further includes a gasket installed in the interface between the cylinder head and the cylinder liner.

3. The engine of claim 2, wherein the gasket includes a plurality of passages, the passages are sealed by sealing elements.

4. The engine of claim 3, wherein the passages is at least one of a coolant flow passage.

5. The engine of claim 1, wherein the cylinder head, the cylinder block and the gasket includes aligned openings to receive a mechanical fastener.

6. The engine of claim 1, wherein the compression relief valve sensor assembly includes a temperature sensing element.

7. The engine of claim 3, wherein the compression relief valve sensor assembly is configured to sense the cylinder head temperature closest to the sealing elements at the interface.

8. The engine of claim 1, wherein the compression relief valve is connected to an engine control module by a wire harness.

9. The engine of claim 8, wherein the engine control module's software is configured to generate an engine overheat condition signal indicative of an engine overheat condition based on the cylinder head temperature signal.

10. The engine of claim 1, wherein the bore is a longitudinal bore.

11. A compression relief valve inset in a cylinder head of an engine comprising:
a body having a bore;
a needle disposed in the bore; and
a compression relief valve sensor assembly disposed in at least one of the body or the needle and configured to generate a cylinder head temperature signal proportional of the cylinder head temperature.

12. The compression relief valve of claim 11, wherein the compression relief valve sensor assembly includes a temperature sensing element.

13. The compression relief valve of claim 11, wherein the compression relief valve is connected to an engine control module by a wire harness.

14. The compression relief valve of claim 11, wherein the engine control module's software is configured to generate an engine overheat condition signal indicative of an engine overheat condition based on the cylinder head temperature signal.

15. The compression relief valve of claim 14, wherein the engine control module selectively operates the engine based on the engine overheat condition.

16. The compression relief valve of claim 11, wherein the bore is a longitudinal bore.

17. A method of determining an engine overheat condition comprising:
determining a current cylinder head temperature of an engine by a compression relief valve sensor assembly provided in a compression relief valve;
comparing the current cylinder head temperature with a predetermined cylinder head temperature by an engine control module; and
indicating an engine overheat condition as a function of the difference of the current cylinder head temperature and the predetermined cylinder head temperature by the engine control module.

18. The method of claim 17, further comprising indicating the engine overheat condition by the engine control module if the current cylinder head temperature is more than the predetermined cylinder head temperature.

19. The method of claim 17, further comprising operating the engine by the engine control module based on the engine overheat condition.

20. The method of claim 17, further comprising sensing the current cylinder head temperature by a temperature sensing element disposed in the compression relief valve sensor assembly.
